(19) United States
(12) Patent Application Publication
(10) Pub. No.: US 2014/0006000 A1
(43) Pub. Date: Jan. 2, 2014

(54) BUILT-IN RESPONSE TIME ANALYTICS FOR BUSINESS APPLICATIONS

(71) Applicants: Bare SAID, St. Leon (DE); Frank BRUNSWIG, Heidelberg (DE); Frank JENTSCH, Muehlhausen (DE)

(72) Inventors: Bare SAID, St. Leon (DE); Frank BRUNSWIG, Heidelberg (DE); Frank JENTSCH, Muehlhausen (DE)

(73) Assignee: SAP AG, Walldorf (DE)

(21) Appl. No.: 13/539,967

(22) Filed: Jul. 2, 2012

(51) Int. Cl. G06F 9/44

(52) U.S. Cl. 703/22

(57) ABSTRACT

A method for performing response time measurements may include defining rules for response time collecting in a metadata object model. The response time measurements defined at the metadata object level may be may be collected during a user session that uses one or more metadata object models in accordance with modeled information in an object model. The collected response time measurements may be transformed to modeled response time data. The modeled response time data may be associated with the object model and used to generate a report of the response time measurements.

### BACKGROUND

The present disclosure generally relates to analyzing performance of applications and specifically to response time analytics.

Software performance and response time analyses are essential parts of software development. However, the analysis of software performance and response time analysis contribute to the overall cost of the software because the analysis require specialized performance experts to perform the analysis. Specialized performance experts are required to perform the analysis because the analysis often times relies on highly technical details to categorize the performance of the software and to determine changes that should be made to improve the software performance.

Furthermore, the analysis includes analyzing and comparing large amount of logged data and tracing the data on a very low technical level using specialized tools. The need to analyze large amount of data and the specialized tools add to the time required for the analysis and the overall cost of the software.

Thus, there is a need for methods and systems to enable a user to easily and efficiently analyze performance of components in applications.

### BRIEF DESCRIPTION OF THE DRAWINGS

The accompanying drawings illustrate the present invention and, together with the description, further serve to explain the principles of the invention and to enable one skilled in the pertinent art to make and use the invention.

FIG. 1 depicts a system including a user interface and a server according to an embodiment.

FIG. 2 illustrates an example of a report for collected response time data.

FIG. 3 is a flowchart illustrating the operation of a system according to an embodiment of the present disclosure.

FIG. 4 is a block diagram of an exemplary computer system.

### DETAILED DESCRIPTION

Embodiments of the present invention provide systems and methods to enable a user to efficiently and easily analyze performance of components in applications. The embodiments provide a built-in development infrastructure component, that may allow a user, such as a developer, quality engineer or end user without performance expertise, to analyze, compare and/or localize critical response time measurements. The embodiments provide for a system and method that are easy to use and provide quick results.

Different response time measurements may be collected for each models (e.g., user interface models). The response time measurements may be collected and assigned to the corresponding service or user interaction which is part of the object model. Rules can be defined generically on the metadata object level. The rules can be used to collect and assign the response time measurements to the object model.

In an embodiment, a generic response time measurement adapter can be used to collect the response time measurements. The response time measurement adapter can be a runtime user interface plug-in that operates during the user session. The generic collection of response time data at each run enables an immediate execution of response time analysis. The embodiments provide for an easy analysis to be performed because the analysis may be performed on the model level, reflecting the domain and information level that is familiar to the user. The embodiments of the present disclosure also provide for an easy and powerful analysis by using development infrastructure capabilities and tools, which support doing analytics on development entities. Examples of creating multi dimensional reports having different response times as key figured and different models or model parts as dimension or characteristics can be found in U.S. U.S. patent application Ser. No. 13/249,231, entitled “REAL-TIME OPERATIONAL REPORTING AND ANALYTICS ON DEVELOPMENT ENTITIES,” filed on Sep. 29, 2011.

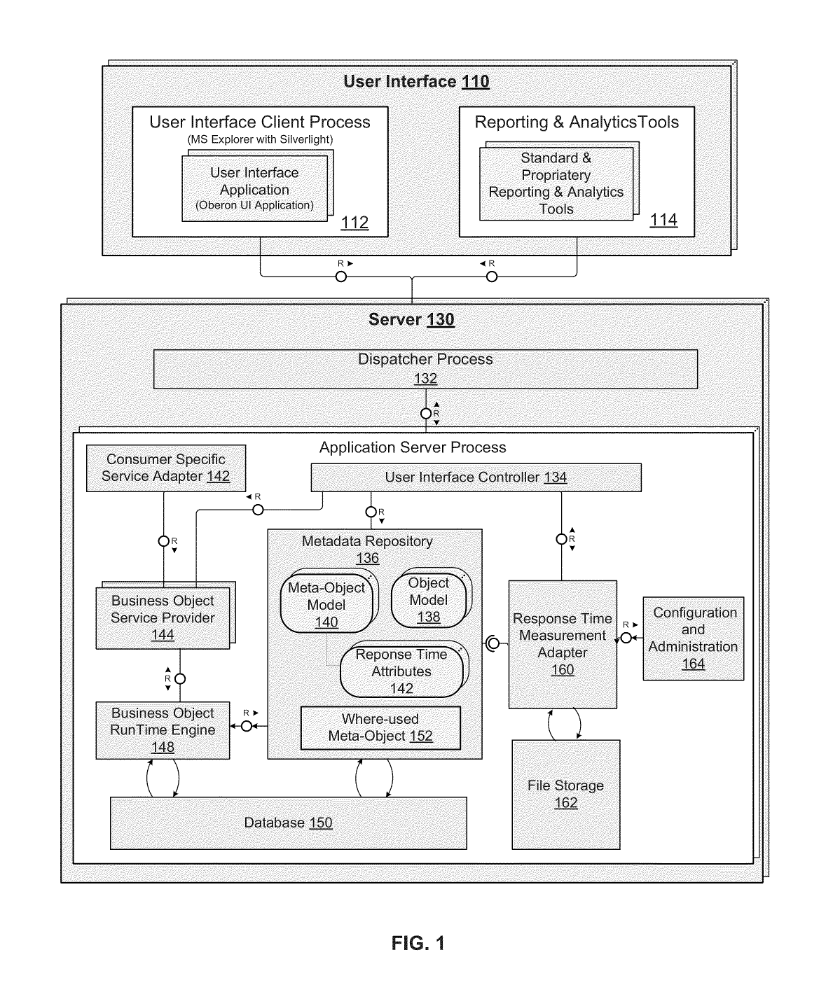

FIG. 1 depicts a system 100 including a user interface 110 and a server 130 according to an embodiment. The user interface 110 may include a user interface client process 112 and reporting and analytic tools 114.

The user interface client process 112 may be implemented as any mechanism enabling interaction with data and/or methods at server 130. For example, user interface process 112 may be implemented as a browser or a thin client application.

The reporting and analytic tools 114 may include standard and proprietary reporting and analytics tools. The reporting and analytics tools may include user interface designer components for designing and configuring the reporting and analytic content. The reporting and analytics tools may include models to be used in connection with the design and configuration of the reporting and/or analytic content. The reporting and analytic tools 114 may also include a spreadsheet component for generating reports and analytic documents, a workbench to design and generate the reports and analytics, dashboards, simple list reports, multi dimensional, pixel perfect reports, key performance indicators and the like.

The reporting and analytic tools 114 may provide a mechanism for building reporting and analytics models on different development entities based on the defined reporting and analytics metamodel in the system, and user interface elements used when building reports and analytics for the development entities. For example, the reporting and analytic tools 114 may use a model stored at server 130 to enable a user to build reports and analytics on the development entities, which are instances of the stored model. Moreover, the reporting and analytic tools 114 may allow defining and/or configuring a reporting model, which is then stored in server 130. This defined report model may be used to define a flat report or analytics for a development entity. For example, the defined report model for the report may define a simple spreadsheet or word processing document, while analytics may be defined by the report model as a more complex pivot table. The report model for the development entities can be stored in the server 130 along with other report models stored at the server 130 for operational business objects. The report models may allow the development entities to use the same reporting and analytics framework as the operational business objects.

User interface models, such as a customer fact sheet or sales order maintaining, may be used to generate and/or use data. The user interface models may be stored at the server 130. The user interface models (which were designed and/or configured during design time for a development entity) may be stored at the server 130 to define a report and/or analytics for the development entity. The model can be stored in the server 130 along with other models stored at the server 130, enabling the model for the development entities to use the same framework.

A user may be able to execute, during runtime, the as-built operational report and analytics by sending a request via the user interface client process 112 and the server 130. The request can be sent via the dispatcher process 132 in the server 130 and handled by the user interface controller 134. Processing of the request may occur and a corresponding report or analytic document can be generated for the development entity based on the stored object model 138 in the metadata repository 136. The metadata repository may be a business object based metadata repository.

The server 130 may include a consumer specific service adapter 142, a business object service provider 144 a business object run time engine 148, and a database 150. The consumer specific service adapter 144 may include specific consumer services to create and manage business object instances. The business object service provider 144 can include a set of service for operating on the business data of the plurality of business objects. For example, the services may include operations that can be executed on the business objects such as, deleting, creating, updating an object, and so on. For examples of using developing business objects for reporting and analytics see U.S. U.S. patent application Ser. No. 13/249,231, entitled “REAL-TIME OPERATIONAL REPORTING AND ANALYTICS ON DEVELOPMENT ENTITIES,” filed on Sep. 29, 2011.

The database 150 may include business object information (e.g., business data for the business object sales order and/or product) and development entity information (e.g. models and for the business objects, work centers, and/or process agents). The database 150 may be implemented as an in-memory database that enables execution of reporting on operational business data or development entities in real-time. The database 150 may store data in memory, such as random access memory (RAM), dynamic RAM, FLASH memory, and the like, rather than persistent storage to provide faster access times to the stored data. The where-used meta-object 152 may include association information defined between models or metamodels.

The business object runtime engine 148 (also referred to as an engine, a runtime execution engine, and/or an execution engine) may receive from the user interface controller 134 a request for a report on a development entity. The business object runtime engine 148 may access the meta-object data in the metadata repository 136 and the where-used meta-object 152 to determine, for example, what development entity to access, where the development entity is located, what data to access from the development entity, and how to generate a report and/or analytics to respond to the request received from the user interface controller 134. The object runtime engine 148 may also access the meta-object model 140 and/or object model 138 to access a model to determine what development entity to access, what data to access from the development entity, and/or how to generate a report and/or analytics. The object runtime engine 148 may also access where-used meta-object 186 to determine further associated entities. The object runtime engine 148 may also access database 150 to obtain data for the development entity corresponding to the business object or other development object model being developed and to obtain data for the report and/or analytics.

The system 100 may use the user interface models (M1-level entities) and the metadata models (M2-level entities) defined in a metadata repository 136. The metadata model repository 136 may also store business object models, response time measurement points, and other development entities models as a repository model using the metadata model. Models defined in the metadata repository 136 can be exposed to the reporting and analytics framework of system 100, although different models, such as a model representing business entity like a sales order business object, or a model representing a development entity in a development area, may be treated the same by the reporting and analytics framework of system 100.

The response time measurement points can be generically defined at the metadata object level (M2-level entities). Thus, the user interface metadata object in the metadata repository 136 may be enhanced with additional attributes and/or model components that are used to define and store different response times. The attributes may be used to introduce in a generic way different response time measurement points in the different user interfaces (e.g., customer fact sheet or sales order maintaining). The benefit of this approach is that the attributes and the model components are inherited by all user interface models (M1-level entities). That is, the attributes and the model components can automatically be parts of each user interface model defined, based on the user interface metadata object model in the metadata model repository 136.

The generic response time definition may also allow a generic implementation of the response time measurement adapter that executes the measurement and collects response time information. Response time measurement points may be defined in a way that their evaluation can reflect the end user perception of system performance during the session. For example, the list below shows possible response time measurement points.
User Interface initialization: Duration time between the event of starting an application and the event signaling the completion of rendering. The duration can be composed by backend and frontend response time measurements.
User Interaction triggering business event (e.g., business action related to push button): Duration time to execute the action defined in the user interface model and in the corresponding business object (e.g., release order or create invoice instruction).
User Interaction triggering generic event (e.g. save data): Duration time between pushing save button and getting the control again.
User interaction requesting value help: Duration time between pushing a value help button and data receiving. The Response time Value and the corresponding value help service are logged.
Business data retrieval per node or node collection: Duration needed to retrieve and render the specified business data.
Business data modification: Duration needed for a frontend user interface controller to transfer modified business data to the backend and to get the control again. Round trip for data retrieval to get new modified data can be not included.
User Interaction triggering chain of events: Duration time to execute a chain of events. Response times can be measured per events and per event chain.
Over all Session response times: Set of response times which is session specific and user interface model specific. The set can contain the longest response time and/or the fastest response time.

Additional response time measurement points can be easily introduced in the metadata repository. Thus, the user interface metadata object level (M2-level entities) can be enhanced by defining new measurement points and automatically generating the new measurement points in all of the user interface models. Other applications (e.g., response time measurement adapter 160) accessing the user interface models can be updates with the measurement points.

Because the response times can be part of the user interface model, analytical reports can be defined on top of the user interface model using the embedded business analytics and reporting frame work in the development infrastructure. Furthermore, holistic and flexible response time analysis can be carried out on one or more user interface models. In addition, the response time analysis can be carried out on all of the user interface models.

The server 130 may further include a response time measurement adapter (RSTM-Adapter) 160. The RSTM-Adapter 160 may be introduced in the backend to manage the collection of the response times. The RSTM-Adapter 160 may perform the response time measurements in coordination with the user interface client process 112. The response time measurements may be collected during the end user session in accordance with the modeled information in the user interface models. The RSTM-Adapter 160 may collect the response time measurements of one or more activities of a frontend client (e.g., user interface client process 112) or a backend user interface controller (e.g., user interface controller 134). The collected response time measurements may be stored in file storage 162 for later analysis. The file storage 162 may be a generic log file. The response time can be collected during the user session and stored immediately in a log file.

The RSTM-Adapter 160 may read the response time measurement points defined in the user interface model. The RSTM-Adapter 160 may access the metadata repository 136 to read the response time measurement points defined in the user interface model.

The RSTM-Adapter 160 may perform a background process to read the stored response time measurement points and assign the captured response times to the corresponding part or service in the user interface model. The RSTM-Adapter 160 may start the background process to read the log file automatically after the end of the user session. The response time measurements may be read from the log file.

The RSTM-Adapter 160 may read and assign the response time measurement points collected after the user ends a session. Thus, the response time measurement points may be transformed to a modeled response time data. The assigned response times may be saved as part of the user interface models in the metadata repository 136. For example, the response time data may be assigned to the corresponding model attribute or model part in the corresponding user interface model. The assigned response times may be saved in the metadata repository 136 as part of the user interface models.

The operation and measurement mode of the RSTM-Adapter 160 may be controlled by a configuration and administration unit 164. A user may control the operation of the RSTM-Adapter 160 via the configuration and administration unit 164. The configuration and administration unit 164 may allow an end user to switch the measurements of the response time on and off. The configuration and administration unit 164 may also allow the end user to control the measurement mode of the RSTM-Adapter 160. For example, a measurement mode may be selected to only capture the slowest, fastest, or average response time per measurement point. Another measurement mode may capture a detailed response time logging by capturing the response time for each call. The RSTM-Adapter 160 may read the configuration information, such as measurement to capture or the response time capturing mode, from the configuration and administration unit 164 when the session is started. Specific application program interfaces may be provided to manage the log file.

The assigned response times can be saved in the metadata repository 136 as parts of the user interface models. Thus, analysis can be performed on the response time data which is part of the user interface models. For example, an embedded analytics framework can be used to analyze the response time when business data reporting is performed. The response time data during the business data reporting can be collected for performance relating to the user interface and/or the business applications.

The ability to perform the analysis allows the user, such as the developer or the end user, to analyze the response times of all the business applications quickly and with minimal user involvement. The assigned response times also allow the user to find potential deterioration in the response time and/or the source of the deterioration. Deterioration in the response time due to changes in the code due to software corrections, software changes or other development activity can also be easily determined.

Reports can be created of the collected response time and/or the performed analysis. For example, the embedded analytics framework in can allow reporting and/or analytics on the models in the metadata repository 136. Specifically, analytics framework in an application platform (AP) can enable business-similar reporting and analytics on the models in the metadata repository 136. In some embodiments, the AP may include the Business ByDesign System provided by SAP AG. The user, such as the developer or the end user, can create the reports and/or perform the analysis on the response time data of a business application by defining parameters (e.g., report base) on the user interface model.

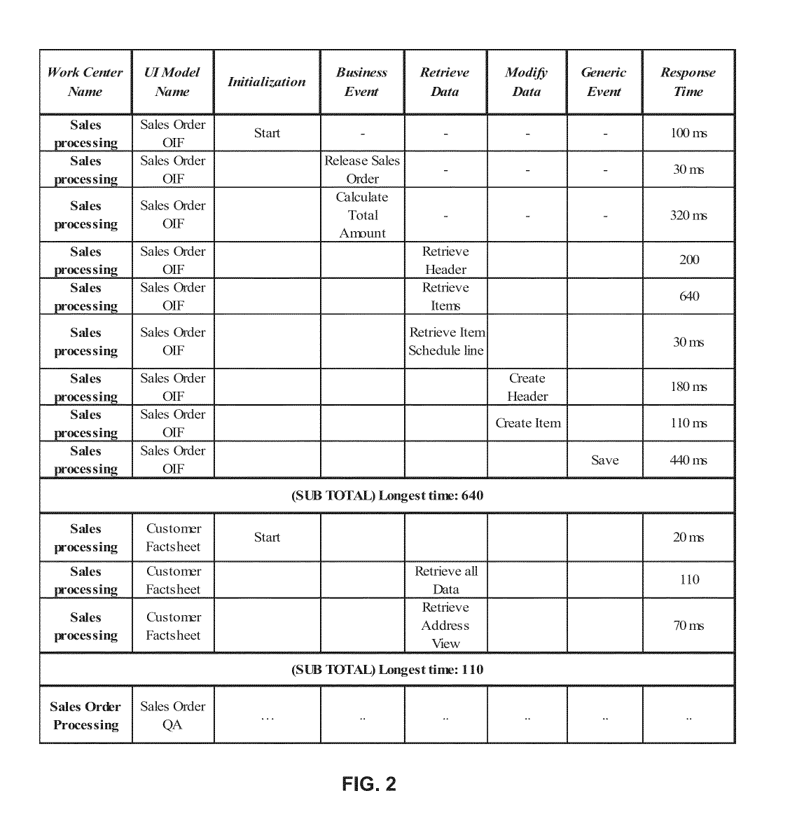

FIG. 2 illustrates an example of a report for collected response time data. As shown in FIG. 2, the report may include a work center name corresponding to a collection of applications needed by the end user to execute tasks. The report may also include a user interface model corresponding to collection of screens assigned to a specific work center. The report can include the response time defined on the user interface models. The defined response times can be clustered into different categories. For example, the response times can be clustered into categories such as business event or retrieve data event.

As shown in FIG. 2, the report may include the response times associated with different categories for each user interface model. In addition, the longest time for each user interface model, such as the sales order user interface model and for the customer factsheet model, may be included. Although, not shown other results of the analysis, such as total time for the user interface model, shortest time and average time per category, can be provided in the report.

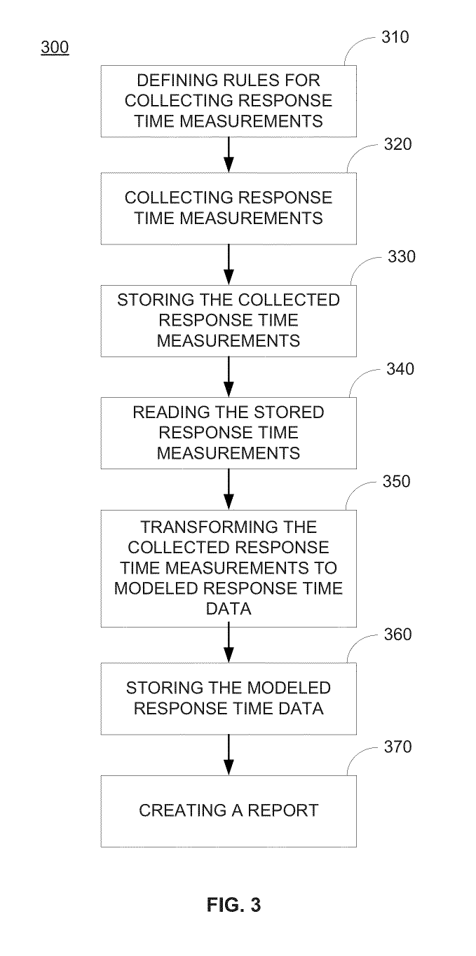

FIG. 3 is a flowchart 300 illustrating the operation of a system according to an embodiment of the present disclosure. The method illustrated in FIG. 3 can be implemented on the system 100 shown in FIG. 1 and on other systems in manner consistent with the present disclosure. It is also to be understood that the method illustrated in FIG. 3 may be implemented without every step illustrated in FIG. 3 being part of the method. Thus, additional method may be implemented with one or more of the steps illustrated in FIG. 3, in a manner consistent with the present disclosure.

The method of performing response time measurements may include defining rules for collecting response time measurements (step 310), collecting response time measurements (step 320), storing the collected response time measurements (step 330), reading the stored response time measurements (step 340), transforming the collected response time measurements to modeled response time data (step 350), storing the modeled response time data (step 360) and creating a report (step 370).

Defining rules for collecting response time measurements (step 310) may include defining rules for the response time collecting in a metadata object model (metadata object level). The rules may include attributes defining response time measurement points. The response time measurement points may be generically defined at the metadata object level and propagated automatically to all models (instances) of the metadata object.

Collecting response time measurements (step 320) may include collecting the response time measurements during a user session that uses one or more metadata object models in accordance with the modeled information in an object model. The one or more metadata object models may include the rules defined in step 310.

Storing the collected response time measurements (step 330) may include storing the response time measurement during the user session. The collected response time measurement can be stored in the memory of the system on which the user session is performed, in an external memory or a log file.

Reading the stored response time measurements (step 340) may include reading the store response time measurements from the memory of the system on which the user session is performed, in an external memory or a log file. The reading of the stored response time measurements can be performed after the user session. The stored response time measurements can be read to provide the collected response time measurements for the transforming of the collected response time measurement to modeled response time data (step 350).

Transforming the collected response time measurements to modeled response time data (step 350) may be performed automatically after the end of the user session. A setting can be made by the user to determine whether the transforming of the collected response time measurements should be performed automatically after the user session. The transforming of the collected response time measurements can be delayed by the user or can be delayed until another user session is finished. Transforming the collected response time measurements may include assigning model attributes or model parts in the corresponding object model and storing the modeled response time data as part of the model.

Storing the modeled response time data (step 360) may include storing the modeled response time data in association with one or more of the metadata object model and the object model. The modeled response time data may be stored in the metadata repository 136 shown in FIG. 1.

Creating a report (step 370) may include creating a report of collected response time measurements. The report may be created using the modeled response time data. An example of a report is shown in FIG. 3. The report may include at least one of the slowest response time, a fastest response time, and an average response time.

Although, some of the embodiments of the present disclosure are discussed with reference to user interface models, the embodiments may be used for other models. For example, response time measurements may be defined for metadata objects such as business object or process agent.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

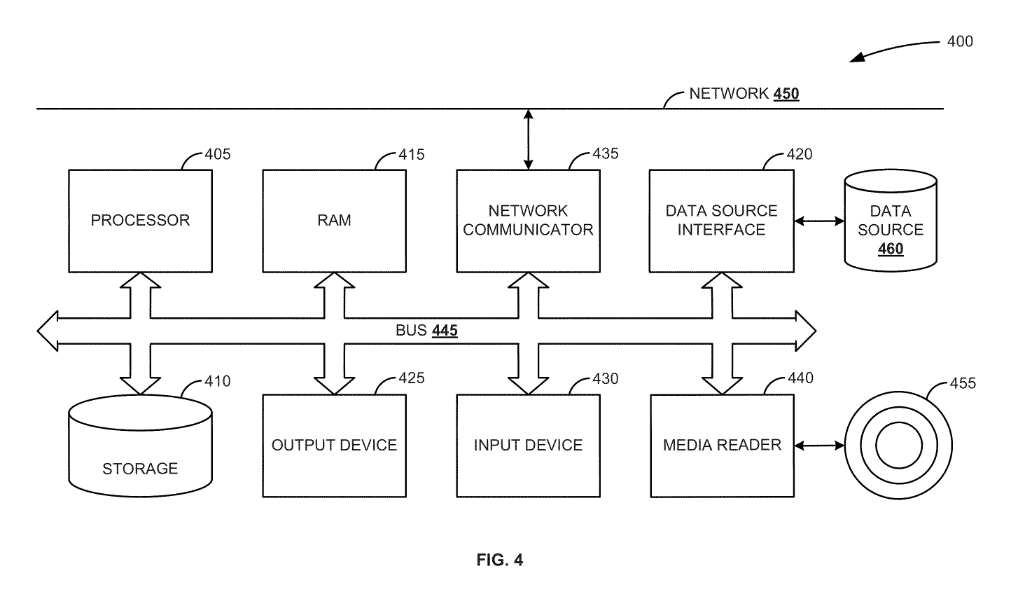

FIG. 4 is a block diagram of an exemplary computer system 400. The computer system 400 includes a processor 405 that executes software instructions or code stored on a computer readable storage medium 455 to perform the above-illustrated methods of the invention. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 500. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

We claim:

1. A method for performing response time analytics, comprising:
defining rules for collecting response time measurements in a metadata object model;
collecting response time measurements during a user session that uses one or more instances of metadata object models in accordance with modeled information in an object model; and
transforming the collected response time measurements to modeled response time data.

2. The method of claim 1, further comprising:
storing the collected response time measurements during the user session in a log file; and
reading the collected response time measurements in the log file after the user session for transforming the collected response time measurements.

3. The method of claim 2, wherein reading and transforming the collected response time measurements are performed automatically after the user session.

4. The method of claim 1, further comprising storing the modeled response time data as part of the object model.

5. The method of claim 1, further comprising creating a report of the modeled response time data.

6. The method of claim 5, wherein the report includes at least one of a slowest response time, a fastest response time, and an average response time.

7. The method of claim 1, wherein transforming the collected response time measurements to the modeled response time data includes assigning model attributes in the object model and storing the modeled response time data as part of the object model.

8. The method of claim 1, wherein the rules include attributes defining response time measurement points.

9. The method of claim 8, wherein the response time measurement points are generically defined at the metadata object level.

10. The method of claim 1, wherein the response time measurement points are defined in a way that their evaluation reflects the user perception of system performance during the session.

11. The method of claim 1, wherein the object model is a user interface object model and the metadata object model is a user interface metadata object model.

12. The method of claim 1, wherein the object model is a business object model and the metadata object model is a business metadata object model.

13. The method of claim 1, wherein the rules include a measurement mode for collecting the response time measurements.

14. The method of claim 13, wherein the measurement mode is set by a user.

15. A non-transitory computer readable medium storing a program causing a computer to execute a process for performing response time analytics, the process comprising:
defining rules for collecting response time measurements in a metadata object model;
collecting response time measurements during a user session that uses one or more metadata object models in accordance with modeled information in an object model; and
transforming the collected response time measurements to modeled response time data.

16. The non-transitory computer readable medium according to claim 15, wherein the process further comprises:
storing the collected response time measurements during the user session in a log file; and
reading the collected response time measurements in the log file after the user session for transforming the collected response time measurements.

17. The non-transitory computer readable medium according to claim 15, wherein the process further comprises storing the modeled response time data as part of the object model.

18. The non-transitory computer readable medium according to claim 15, wherein the process further comprises creating a report of the modeled response time data.

19. The non-transitory computer readable medium according to claim 15, wherein transforming the collected response time measurements to the modeled response time data includes assigning model attributes in the object model and storing the modeled response time data as part of the object model.

20. An apparatus for performing response time analytics, comprising
a data repository to store one or more metadata object models and one or more object models; and
a computer comprising a memory to store a program code, and a processor to execute the program code to:
define rules for collecting response time measurements in a metadata object model stored in the data repository;
collect response time measurements during a user session that uses one or more metadata object models in accordance with modeled information in an object model; and
transform the collected response time measurements to modeled response time data.
